(19) United States
(12) Patent Application Publication
(10) Pub. No.: US 2006/0007154 A1
(43) Pub. Date: Jan. 12, 2006

(54) Optical detection of relative motion

(75) Inventor: Jeffrey Raynor, Edinburgh (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics Ltd., Marlow (GB)

(21) Appl. No.: 11/170,985

(22) Filed: Jun. 30, 2005

(30) Foreign Application Priority Data
Jul. 7, 2004 (EP) 04254080.7

(51) Int. Cl. G09G 5/08

(52) U.S. Cl. 345/166

(57) ABSTRACT

In an apparatus, such as an optical mouse, relative motion between itself and an adjacent surface is detected. A lens focuses an image of the illuminated adjacent surface, and an image sensor receives the image and generates picture signals representing sequential frames of the image. A high-pass filter may filter the picture signals. An image processor may receive the high-pass filtered picture signals for correlating successive frames of the picture signals to derive an output representing the relative motion.

### FIELD OF THE INVENTION

The present invention relates to the analysis of images to detect motion, and in particular, to an optical computer pointing device, e.g., a computer mouse. The present invention may be equally applicable to other situations requiring motion detection from sequential images, and also relates to integrated circuits adapted for this purpose.

### BACKGROUND OF THE INVENTION

An optical mouse has advantages in comparison to mouses that rely on electromechanical devices incorporating balls or rollers. U.S. Pat. No. 5,729,008 discloses an optical mouse in which a light beam is projected onto a work surface, such as a mouse pad. The resulting illuminated area of work surface is imaged by a 2D image sensor to produce a sequence of images, and XY movement signals are derived by signal processing which is based on correlation of sequential images.

This known technique requires the work surface to have sufficient granularity to provide image detail to enable the correlation to be made. It is also prone to errors caused by optical deficiencies, such as a non-uniform illumination of the work surface, which may be caused by misalignment of the projection system. Errors may also be caused by a poor focus of the imaging lens, and non-perpendicularity of the sensor axis with respect to the work surface.

U.S. Pat. No. 6,603,111 describes the use of spatial filtering in a computer mouse, but only in the context of enhancing motion along specific axes (45 degrees to the X and Y axes).

### SUMMARY OF THE INVENTION

An object of the present invention is to overcome or reduce the above described problems. More generally, the present invention seeks to improve the processing of sequential image signals involving correlation between successive images.

This and other objects, advantages and features in accordance with the present invention are provided by a method for detecting relative motion between an optical assembly and an adjacent surface. The method may comprise illuminating the surface, imaging the illuminated surface onto an image sensor, generating picture signals representing sequential frames of the image, and deriving motion information by correlating successive frames. The picture signals are preferably high-pass filtered before performing the correlation.

The picture signals are in, or may be converted into, a digital form before being subjected to the high-pass filtering. The filtering may be performed by a matrix operation. The method may further comprise pre-processing the digital signals before the filtering. The pre-processing may comprise a correlated double sampling (CDS) method.

Another aspect of the present invention is directed to an apparatus for detecting relative motion between itself and an adjacent surface. The apparatus comprises a light source for projecting a light beam towards the surface for illumination thereof, a lens mounted to focus an image of the illuminated surface onto an image sensor, and an image sensor for generating picture signals representing sequential frames of the image.

The apparatus may further comprise image processing means or an image processor for correlating successive frames of the picture signal to derive an output representing the relative motion. A high-pass filter is preferably between the image sensor and the image processor.

The image sensor may comprise a pixel array in combination with read-out and analog-to-digital conversion circuits, and the high-pass filter may be between the analog-to-digital conversion circuit and the image processor. The high-pass filter may apply a matrix operation to the digitized signal, and may include gain control means or controller for separately adjusting the gain of high pass and low pass channels.

The image sensor may further comprise image pre-processing means or a pre-processor between the analog-to-digital conversion circuit and the high-pass filter. The apparatus of the invention preferably comprises or forms part of an optical mouse.

Yet another aspect of the present invention is directed to an integrated circuit comprising a light-sensitive image plane forming an array of pixels, a read-out circuit for reading out pixel values to form a picture signal, and an analog-to-digital conversion circuit for converting the picture signal to a digital format. An image processor may correlate successive frames of the picture signal to derive information therefrom. The integrated circuit preferably further comprises a high-pass filter connected between the analog-to-digital conversion circuit and the image processor.

The high-pass filter may apply a matrix operation to the digitized signal, and may include gain control means or a gain controller for separately adjusting the gain of high pass and low pass channels. The integrated circuit may also further comprise image pre-processing means or a pre-processor between the analog-to-digital conversion circuit and the high-pass filter.

### BRIEF DESCRIPTION OF THE DRAWINGS

An embodiment of the invention will now be described, by way of example, with reference to the drawings, in which:

FIG. 1 is a schematic diagram of an optical mouse according to the prior art;

FIG. 2 is a schematic diagram of an optical mouse according to a first embodiment of the present invention;

FIG. 3 is a schematic diagram of an optical mouse according to a second embodiment of the present invention;

FIG. 4 is a block diagram illustrating in greater detail the filter shown in FIGS. 2 and 3; and

FIG. 5 shows one example of a filter matrix that may be used in the filter illustrated in FIGS. 2-4.

### DETAILED DESCRIPTION OF THE PREFERRED EMBODIMENTS

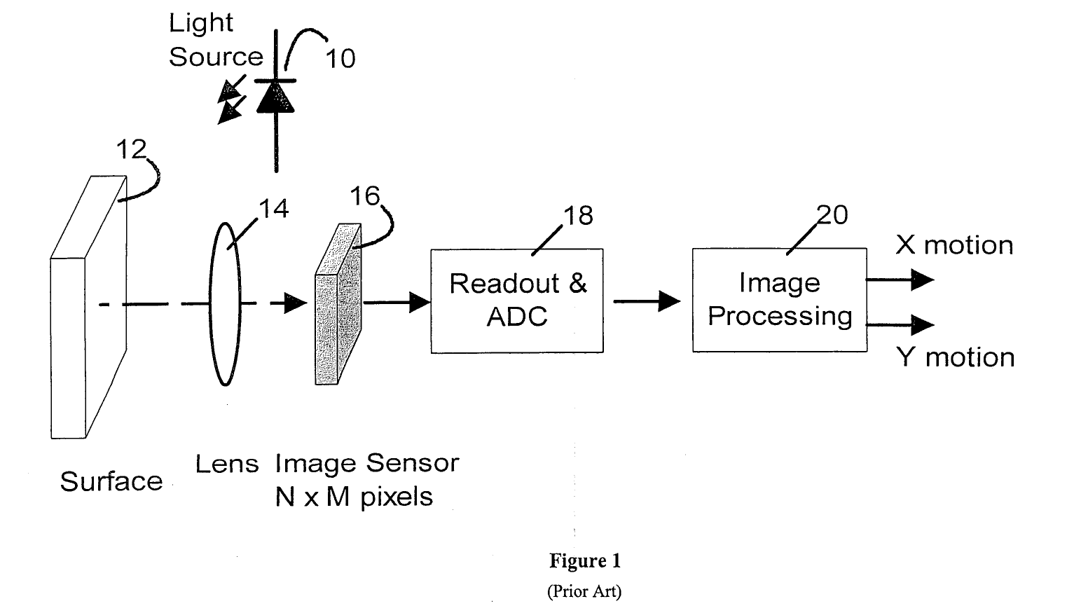

Referring to FIG. 1, in a known optical mouse a light source 10, such as a LED, illuminates a work surface 12. The illuminated surface 12 is imaged by a lens 14 onto an image sensor 16. The lens 14 may be implemented by a single lens or by more sophisticated imaging optics.

The image sensor 16 will typically be a sensor having a two-dimensional array of N×M pixels, such as a CMOS single chip sensor. The output of the image sensor 16 is read out and converted to digital form in a read-out and ADC circuit 18 in a manner well known by those skilled in the art to provide digital image data of sequential frames to an image processing circuit 20.

The image processing circuit 20 derives X and Y motion of the mouse relative to the work surface 12 by applying correlation techniques to successive image frames. Such techniques are well established in the art and need not be described here.

The image processing requires the digitized image to feature a minimum amount of texture, contrast, granularity, and uniformity of illumination. The image processing can be adversely affected by factors such as a non-uniform illumination of the work surface and poor alignment of the optics, such as the lens 14 not having its optical axis truly perpendicular to the work surface, or the image plane of the sensor is not being truly parallel to the work surface.

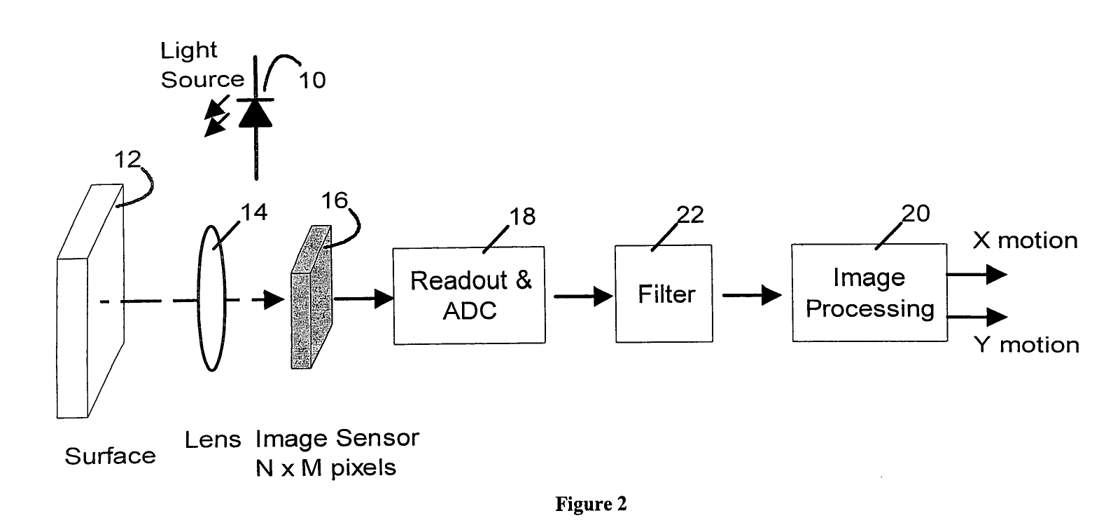

Referring now to FIG. 2, a first embodiment of the present invention contains the same elements as in FIG. 1, denoted by the same reference numerals. In this embodiment, however, a high-pass filter 22 is between the read-out and ADC circuit 18 and the image processing circuit 20.

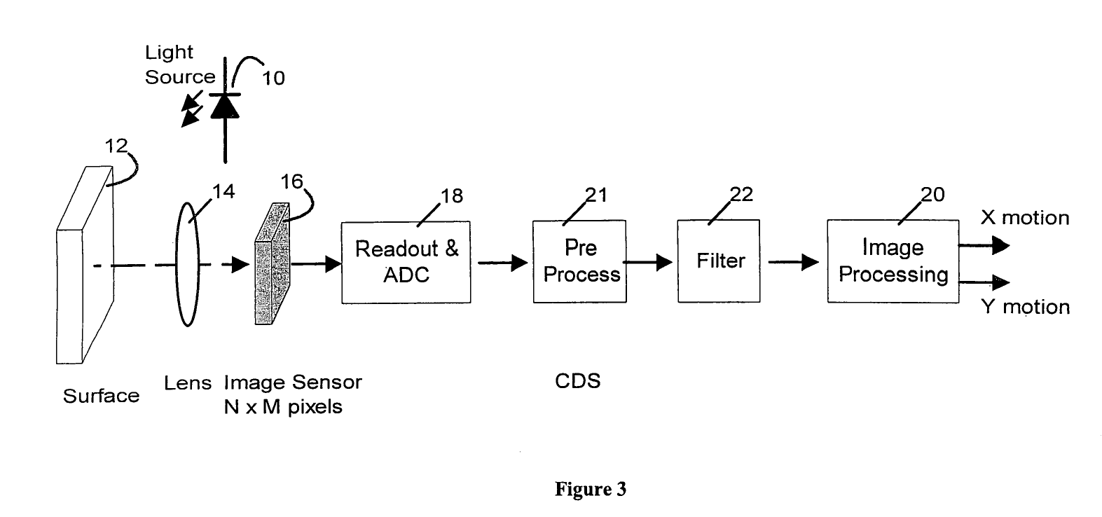

FIG. 3 shows a second embodiment, which comprises the same elements as in FIG. 2, denoted by the same reference numerals. In this embodiment, however, an image pre-processor 21 is interposed between the ADC 18 and the image processor 20.

The image pre-processor can be used to manipulate the detected signals to increase the performance of the downstream correlation by detecting and removing noise from the detected image, or removing offset from the detected image, for example. Any suitable noise reduction technique can be used, such as a correlated double sampling (CDS), for example, either in standard or modified form.

Many methods to high-pass filter an image are known by those skilled in the art. One of the simplest methods uses a 3×3 matrix operation as shown in FIG. 5. This provides a spatial high pass filter, which removes image DC components and amplifies pixel-to-pixel transitions.

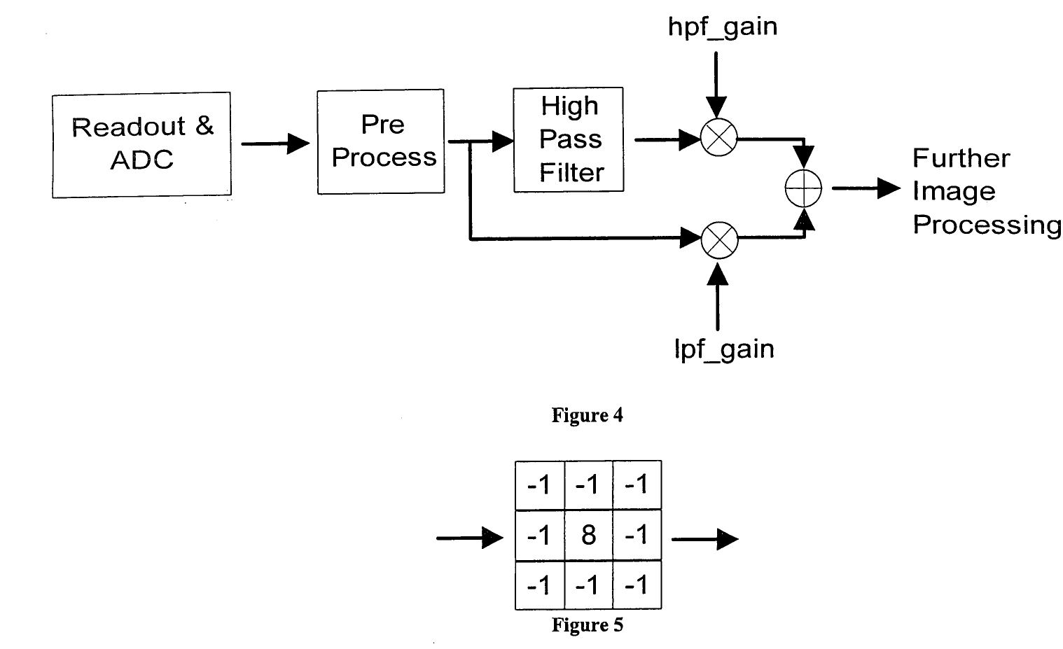

FIG. 4 shows a generalized representation of the filter step, with the possibility of tuning high-pass and low-pass gain. The gain tuning can be manual or automatic, for example, in a loop that analyses image statistics.

The filtering may assist motion detection on low granularity surfaces or in non-optimized lens focus conditions by enhancing high spatial frequencies and reducing low frequency shading effects. For instance, where the axis of the sensor is not perfectly perpendicular is one example.

The circuitry shown in FIGS. 2 and 3 can be incorporated into a single integrated circuit chip. The image sensor 16 may suitably be a CMOS image sensor, and the other circuits can then be readily formed in the same CMOS chip. In a CMOS image sensor, the pixel readout will be analog, which is then converted to digital, but the invention can be applied to other forms of sensor, including those giving a direct digital output.

Reference is directed to a copending patent application (Attorney Docket No. 04EDI01352803) filed concurrently herewith and is assigned to the current assignee of the present invention, the entire contents of which is incorporated by reference herein. The copending patent application discloses the filtering technique described herein but is also directed to other features of an optical mouse.

1-22. (canceled)

23. A method for detecting relative motion between an apparatus and an adjacent surface, the method comprising using the apparatus to:
illuminate the adjacent surface;
image the illuminated adjacent surface onto an image sensor;
generate picture signals representing sequential frames of the image;
high-pass filter the picture signals; and
derive motion information from the high-pass filtered picture signals by correlating successive frames thereof.

24. A method according to claim 23, further comprising digitizing the picture signals before the high-pass filtering.

25. A method according to claim 24, wherein the high-pass filtering is performed with a matrix operation.

26. A method according to claim 24, further comprising pre-processing the digital signals before performing the high-pass filtering.

27. A method according to claim 26, wherein the pre-processing comprises correlated double sampling (CDS).

28. An apparatus for detecting relative motion between itself and an adjacent surface, the apparatus comprising:
a light source for illuminating the adjacent surface;
a lens for focusing an image of the illuminated adjacent surface;
an image sensor for receiving the image and generating picture signals representing sequential frames of the image;
a high-pass filter for high-pass filtering the picture signals; and
an image processor receiving the high-pass filtered picture signals for correlating successive frames of the picture signals to derive an output representing the relative motion.

29. An apparatus according to claim 28, wherein said image sensor comprises a pixel array, and a read-out and analog-to-digital conversion circuit connected to said pixel array for digitizing the picture signals; and wherein said high-pass filter is between said readout and analog-to-digital conversion circuit and said image processor.

30. An apparatus according to claim 29, wherein said high-pass filter performs a matrix operation on the digitized picture signals.

31. An apparatus according to claim 29, wherein said high-pass filter comprises high pass and low pass channels; and a gain controller for separately adjusting a gain of the high pass and low pass channels.

32. An apparatus according to claim 26, further comprising an image pre-processor between said readout and analog-to-digital conversion circuit and said high-pass filter.

33. An apparatus according to claim 32, wherein said image pre-processor comprises a correlated double sampling circuit.

34. An optical mouse comprising:
a light source for illuminating an adjacent surface on which the optical mouse is used;
a lens for focusing an image of the illuminated adjacent surface;
an image sensor for receiving the image and generating picture signals representing sequential frames of the image;
a high-pass filter for high-pass filtering the picture signals; and
an image processor receiving the high-pass filtered picture signals for deriving an output representing relative motion of the optical mouse with respect to the adjacent surface.

35. An optical mouse according to claim 34, wherein said image sensor comprises a pixel array, and a read-out and analog-to-digital conversion circuit connected to said pixel array for digitizing the picture signals; and wherein said high-pass filter is between said readout and analog-to-digital conversion circuit and said image processor.

36. An optical mouse according to claim 35, wherein said high-pass filter performs a matrix operation on the digitized picture signals.

37. An optical mouse according to claim 36, wherein said high-pass filter comprises high pass and low pass channels; and a gain controller for separately adjusting a gain of the high pass and low pass channels.

38. An optical mouse according to claim 36, further comprising an image pre-processor between said readout and analog-to-digital conversion circuit and said high-pass filter.

39. An optical mouse according to claim 38, wherein said image pre-processor comprises a correlated double sampling circuit.
